(19) United States
(12) Patent Application Publication
(10) Pub. No.: US 2026/0202185 A1
(43) Pub. Date: Jul. 16, 2026

(54) EXTRINSIC FABRY-PEROT INTERFEROMETER METALLIC SURFACE SENSOR

(71) Applicants: Jie Huang, Rolla, MO (US); Ronald J. O'Malley, Rolla, MO (US); Bohong Zhang, Rolla, MO (US); Abhishek Prakash Hungund, San Diego, CA (US); Hanok Tekle, Kansas City, MO (US); Thomas Spudich, Lake Saint Louis, MO (US); Rex E. Gerald, II, Willow Springs, IL (US)

(72) Inventors: Jie Huang, Rolla, MO (US); Ronald J. O'Malley, Rolla, MO (US); Bohong Zhang, Rolla, MO (US); Abhishek Prakash Hungund, San Diego, CA (US); Hanok Tekle, Kansas City, MO (US); Thomas Spudich, Lake Saint Louis, MO (US); Rex E. Gerald, II, Willow Springs, IL (US)

(73) Assignee: The Curators of the University of Missouri, Columbia, MO (US)

(21) Appl. No.: 19/016,888

(22) Filed: Jan. 10, 2025

(51) Int. Cl. G01B 11/02; G01B 11/04

(52) U.S. Cl. CPC G01B 11/026; G01B 11/046; G01B 2290/25

(57) ABSTRACT

The present invention relates to a method of adapting an Extrinsic Fabry-Perot interferometer (EFPI) to measure the distance between a reflective surface of the EFPI and a metal surface. In one embodiment of the invention, the EFPI is embedded into a mold wall and measures the shrinkage gap size formed between a mold wall and a metal surface as the molten metal solidifies. In another embodiment a plurality of EFPI is placed in any array. The EFPI array and a cast metal surface are configured to move relative to each other such that the distance between the cast metal surface and the reflective surface of the EFPI is measured at a plurality of locations. The present invention further relates to an array of a plurality of EFPI.

### STATEMENT REGARDING FEDERALLY SPONSORED RESEARCH OR DEVELOPMENT

This invention was made with Government support under Prime Agreement No. SP4701-20-C-0076 awarded by U.S. Department of Energy's Office of Energy Efficiency and Renewable Energy (EERE) under the Advanced Manufacturing Office (AMO) SFSA-DLA Steel Performance Initiative. The Government has certain rights in the invention.

### FIELD OF THE INVENTION

The invention generally relates measuring distance from a cast metal surface using an Extrinsic Fabry-Perot interferometer (EFPI). In various embodiments, the present invention can be applied in metal casting operations, including measuring shrinkage (gap size) and solidification of molten metal cast into a mold and measuring surface features of a billet emerging from a continuous caster mold.

### BACKGROUND OF THE INVENTION

Solidification is a fundamental step in metal production, involving the transformation of liquid metal into a desired solid shape. The use of molds is prevalent in this process, as they play a crucial role in shaping the metal. However, the heat transfer dynamics at the mold-metal interface, particularly for complex-shaped castings and continuously cast metals, remain poorly understood. To bridge this knowledge gap, mathematical models integrating solidification, heat transfer, and mechanical stress have been employed to enhance our understanding of the interface gap during solidification in static molds. A thorough understanding of metal solidification is crucial for achieving better control, consistency, and higher-quality metals.

Enhancing metal manufacturing processes often involves the direct measurement of mold gaps and temperature profiles during high-temperature solidification. In the steel casting industries, various methods have been adopted to measure gap size and slab thickness to enhance the yield and casting quality. Conduction-base sensors provide a direct method for gauging the interfacial heat transfer coefficient by capturing heat transfer, predominantly through conduction, facilitating gap size estimations. Linear variable differential transformer (LVDT) sensors have been widely employed for measuring the gap size, however these sensors can be relatively expensive compared to other displacement sensors and require signal-conditionals electronics.

The Fabry-Perot interferometer (FPI) has played a very important role in various optical fields. A FPI typically has a cavity formed between two optical reflectors, known as a Febry-Perot cavity. A variation of the FPI, as shown in FIG. 1(a) is an extrinsic FPI (EFPI) 50 which may have a separate reflective surface, such as a mirror 52 positioned a distance away from an external reflector 54 positioned at the end facet of a lead-in fiber 54 to form a Fabry-Perot cavity 51. The Fabry-Perot cavity 51 of the EFPI 50 consists of an air-gap between the two optical reflectors.

The EFPI includes a fiber-optic sensor that is immune to electromagnetic interference and can operate in harsh environments, unlike LVDT. The EFPI directs a broadband light source onto the reflective surfaces. The light field produced by the broadband light source circulates back and forth in the Fabry-Perot cavity. The cavity length is derived by using the differences in light wavelengths, as shown in FIG. 1(b), and a mathematical model. By tracking the variation of the reflection of an EFPI sensor, subtle changes in the cavity length can be quantified. Advanced algorithms are able to determine changes in the cavity length at sub-nanometer scale, which are correlated to Δλᵥ.

Accurate measurement of interfacial heat transfer during cast solidification is crucial for optimizing metal solidification processes. Therefore, it is desirable to devise a method of using an EFPI to measure the distance between a solidifying metal cast and the mold. Such a method has the potential to enhance control and optimize the solidification process, leading to substantial improvements in product quality and consistency.

### BRIEF SUMMARY OF THE INVENTION

The present invention relates to a method of measuring distance from a cast metal surface using an Extrinsic Fabry-Perot interferometer (EFPI) in which the metal surface serves as one of the reflective surfaces. Various aspects of the invention relate to an adaptation of an EFPI in which a broadband light source of the EFPI is directed onto a metal surface located at a first position and reflecting the light waves incident thereon to a reflector of the EFPI located at a second position to produce an interference pattern read by a sensor of the EFPI, and generating a signal from the interference pattern read by the sensor corresponding to the distance between the first position and the second position. In one embodiment of the invention, the EFPI is placed in a cast mold and the reflector of the EFPI is offset towards the interior of the cast mold surface. When liquid metal is poured into the mold, a reflective surface is formed. As the metal gradually cools and solidifies, it undergoes shrinkage, which can be precisely measured using the EFPI sensor. The sensor measures the change in distance between the cast mold surface and the metal surface as the first position moves relative to the second position as the metal solidifies within the mold.

In another embodiment of the invention, an EFPI is used to measure the distance from a cast metal surface at a plurality of locations by positioning an EFPI sensor such that the broad band light source is generally perpendicular incident to the surface of the cast metal. The broadband light reflects back to the reflector of the EFPI producing an interference pattern read by the sensor of the EFPI. A signal is generated by the sensor corresponding to the distance between the surface of the cast metal and the surface of the reflector. The EFPI sensor or the metal surface may move relative to the other such that the EFPI measures the distance between the metal surface and the EFPI reflector at multiple locations. Further, an array of a plurality of EFPI sensors may be used to measure the distance between the metal surface and the EFPI reflector at a plurality of locations simultaneously.

The present invention is also directed to an EFPI array for measuring the distance from a cast metal surface at a plurality of locations simultaneously. The EFPI array comprises a plurality of EFPI arranged in a linear configuration along a longitudinal axis; two supports on either side of the EFPI array opposite from each other along the longitudinal axis for supporting the plurality of EFPI at a uniform distance from the cast metal surface; and at least one wheel attached to each of the supports for moving the EFPI array relative to the cast metal surface.

Other objects and features will be in part apparent and in part pointed out hereinafter.

### BRIEF DESCRIPTION OF THE SEVERAL VIEWS OF THE DRAWING

FIG. 1(a) a schematic illustration of an Extrinsic Fabry-Perot interferometer (EFPI) and FIG. 1(b) is a graph showing the optical interferograms of the EFPI reflective surfaces;

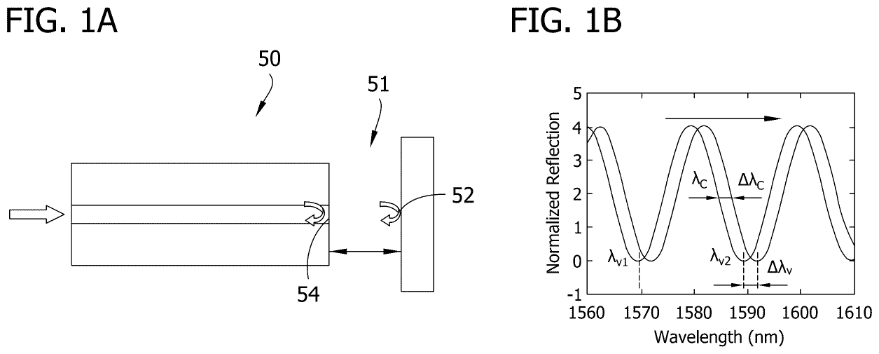

FIG. 2 is a schematic illustration of an EFPI with molten metal as a reflective surface;

FIG. 3 is a schematic illustration of two EFPIs and a thermocouple embedded into a mold wall;

FIG. 4 is a schematic illustration of an EFPI sensor;

FIG. 5 is a schematic illustration of an EFPI sensor and a casted metal surface;

FIG. 6 is a schematic illustration of the EFPI sensor array configured to move relative to the casted metal surface;

FIGS. 7A and 7B are schematic illustrations of alternate views of the EFPI sensor array;

FIG. 8 is a schematic illustration of a deconstructed mold used in Example 1;

FIG. 9 is an alternative view of FIG. 8;

FIGS. 10A, 10B, and 10C are a series of graphs displaying interferograms at regular time intervals;

FIGS. 11A and 11B are graphs displaying the cavity length changes; and

FIGS. 12A and 12B are graphs displaying the results of the EFPI sensor array measurement of a slab.

Corresponding reference characters indicate corresponding parts throughout the drawings.

### DETAILED DESCRIPTION OF THE INVENTION

### Interference Measurement and Calculations

The present invention employs one or more EFPIs. The EFPI is a widely employed optical measurement tool that relies on the interference of light waves. It comprises a pair of flat, parallel reflective surfaces separated by a distance. In the context of the current invention, the EFPI is modified such that one of the reflective surfaces is a metal surface. The metal surface may be molten metal or solid metal. Incident light waves are reflected back and forth between the metal surface and the reflector of the EFPI, resulting in interference patterns as the waves interact. The EFPI may read the interference patterns as the molten metal solidifies. Analyzing these interference patterns provides valuable information, including variations in the distance between the metal surface and another location (e.g., the gap size formed between the surface of a mold and the solidifying metal).

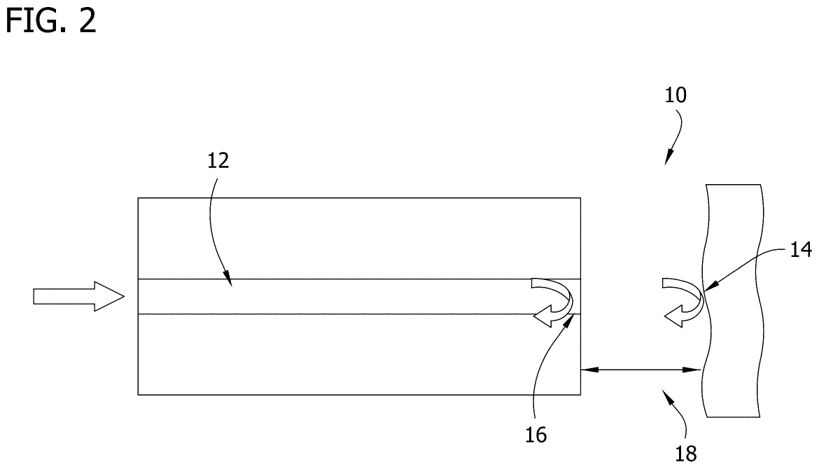

FIG. 2 is a schematic illustration of an EFPI with molten metal as a reflective surface. The EFPI 10 has a sensor 12 that directs broadband light onto a metal surface 14. The light waves incident on the metal surface are reflected to the reflector 16 of the EFPI 10 located at a second position. The light waves create an interference pattern that is read by the sensor 12. A signal is generated by the sensor 12 corresponding to the gap size 18 which is the distance between the first position (i.e., the metal surface 14) and the second position (i.e., the reflector 16). The gap size18 is determined by a series of calculations detailed below. These calculations are conducted by a computer program that is commonly known to those skilled in the art.

The metal surface 14 and the EFPI reflector 16 surface form a gap size of L. The resulting interference signal I is given by:

$$I = {I}_{1} + {I}_{2} + 2 \sqrt{{I}_{1} {I}_{2}} cos ( \frac{4 π nL}{λ} + φ ) \qquad ( 1 )$$

Where I₁ and I₂ represent the light intensities reflected from the metal surface 14 and reflector 16, respectively. Additionally, φ denotes the initial phase difference of the interferometer, n represents the refractive index of air as 1.0000293 (approximately 1), and L indicates the length of the gap size. The change in refractive index of air from room temperature to high temperature is typically small, with minimal impact on most experiments. This change is usually on the order of 10E-6 per ° C. In practical applications and experiments, this change is considered negligible and can be effectively managed through calibration or compensation methods known to those with ordinary skill in the art. The free spectral range (FSR) is the distance between two successive minima in the interferogram. The FSR can be calculated using the following equation as:

$$FSR = \frac{{λ}^{2}}{2 L} \qquad ( 2 )$$

Where λ is the wavelength of the propagated light, which is measured by the EFPI sensor. So, the distance from the metal surface to the EFPI reflector can be demodulated by determining the FSR of the interferogram. The change in distance ΔL, as the molten metal cools, can be determined by:

$$Δ L = \frac{{λ}^{2} Δ FSR}{{FSR}_{1} {FSR}_{2}} \qquad ( 3 )$$

where FSR₁, FSR₂ are the values of FSR before an after displacement, respectively.
EFPI within Mold

One embodiment of the invention is a method of measuring distance from a cast metal surface using an EFPI, comprising directing a broadband light source of the EFPI onto the metal surface located at a first position and reflecting the light waves incident thereon to the reflector of the EFPI located at a second position to produce an interference pattern read by a sensor of the EFPI, and generating a signal from the interference pattern read by the sensor corresponding to the distance between the first position and the second position.

The EFPI sensor is positioned within a wall of a mold. Molten metal is poured into the mold. The molten metal may be any type of metal that is typically placed within a mold. For example, the molten metal may be aluminum. The temperature of the molten metal is typically between 60° and 1600° C. As the molten metal cools, it shrinks and creates a gap size between the mold wall and the metal surface. The gap size increases rapidly as the molten metal cools and shrinks. The molten metal stabilizes after a period of time from about one to ten minutes. As the temperature of the molten metal stabilizes the gap size remains approximately the same.

The EFPI includes a sensor that is constructed of an optical fiber. Optical fiber is beneficial for this method because it is temperature-insensitive at the temperatures used for this method (i.e., between 60° and 1600° C.). An optical fiber that is made of material that is transparent to the light used for EFPI interrogation is suitable.

One aspect of the invention is positioning the EFPI sensor within a mold wall. To ensure proper alignment and secure the EFPI sensor in place, the fibers are cleaved, placed inside a ferrule, and installed through the mold wall. The ferrule may be made of stainless steel, ceramic or any other material that is commonly known in the art that is able to resist deterioration at high temperature. The ferrule may be fixed to the mold wall to ensure the accuracy of gap measurements during the solidification process. For example, the ferrule may be fixed to the mold wall using refractory cement. A single or a plurality of EFPIs may be positioned within the mold walls. For example, three EFPIs may be placed on one wall of the mold such that the EFPIs are displaced vertically with respect to the configuration of the mold. In another example, there may be two EFPIs placed on opposite mold walls.

The EFPI sensor is connected to an optical integrator for data acquisition. In one particular embodiment, the optical integrator is a Micron-Optics Hyperion SI-255, or an equivalent instrument, which is an enhance visibility optical integrator with a broad wavelength band from 1460 nm to 1620 nm. A computer connected to the optical integrator measures/calculates the varying Free Spectral Range (FSR).

The EFPI sensor may be connected to the data acquisition software with a fiber. For example, the fiber may be single-mode silica fiber. The fiber may be in a protective tubing such as a stainless-steel tube or any other tube that is commonly used by one with ordinary skill in the art.

The temperature of the cast metal may be measured as the molten metal solidifies. For example, the temperature is measured using Rayleigh backscattering with a coating-stripped single-mode optical fiber temperature sensor. The temperature sensor may have an outer diameter of 0.125 mm employed across the mold wall and cavity. The coating may be removed from the temperature sensor to mitigate potential mechanical distortions caused by delamination and combustion of the polymer coating.

The temperature sensor may be enclosed within a housing that is a temperature insensitive material. For example, the temperature sensor may be enclosed in a stainless-steel tubing which runs across the mold wall and cavity area. The temperature sensor is connected to a temperature integrator for temperature monitoring. An example of a temperature integrator is the Optical Frequency-Domain Reflectometry (OFDR). One example of an appropriate OFDR integrator for the invention is developed my Luna Innovations Incorporated. The temperature sensor may be connected to the temperature integrator with a fiber. For example, the fiber may be a single-mode silica fiber.

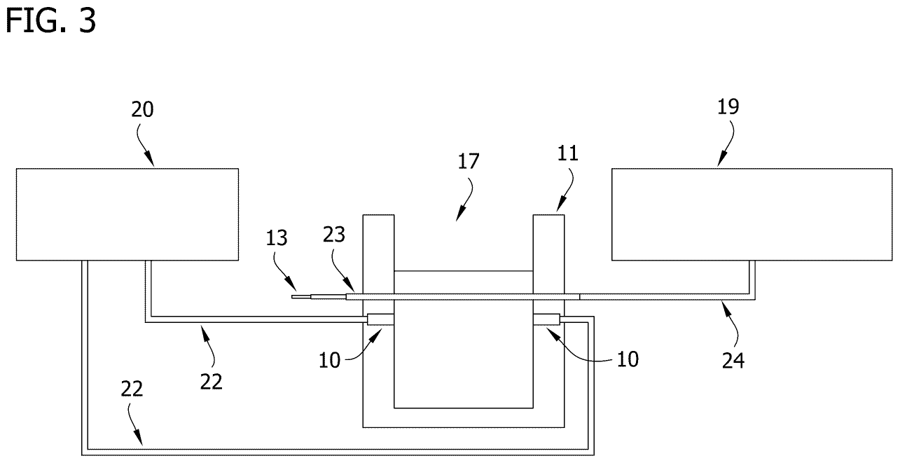

In one embodiment of the invention, the metal is cast within a mold comprising a wall defining a cavity in which the metal is cast. The method is used to determine the gap size formed between the surface of the mold and the surface of the cast metal as the metal solidifies. FIG. 3 is a schematic illustration of an EFPI 10 and temperature sensor 13 embedded into a wall of a mold 11. In this embodiment, two EFPIs 10 are embedded in opposite walls of mold 11 and connected to an optical integrator 20 for data acquisition. The EFPI sensors 10 are connected to the optical integrator 20 with single-mode silica fiber 22. The temperature sensor 13 is housed inside a stainless-steel tube 23 and positioned across the mold 11 wall and the cavity17. The temperature sensor 13 is connected to a temperature integrator 19 for temperature monitoring by single-mode silica fiber 24.

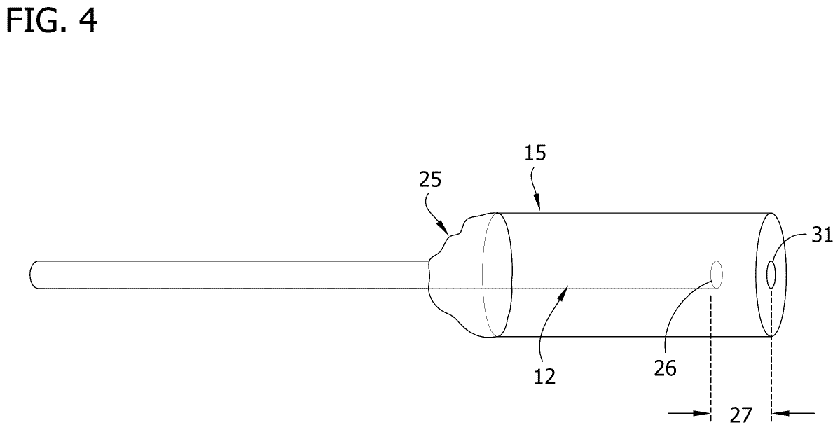

In another embodiment of the invention, the reflector of the EFPI located at the second position is housed in ferrule disposed within the wall of the mold and internally offset from the surface defining the cavity in which the metal is cast. The reflector is located and an end face of the EFPI. As shown in FIG. 4, the EFPI sensor 12 is housed within a ferrule 15. The end face 26 of the EFPI sensor 12 is not flush and is internally offset with the ferrule 15 end face 31 such that the EFPI sensor 12 is internally offset. The ferrule 15 end face 31 is flush with the mold surface in which the ferrule is located. The internal offset 27 assists the sensor to clearly detect the time at which molten metal starts to solidify and to prevent direct contact of molten metal with the EFPI sensor face. The internal offset is typically from about 50 μm to about 130 μm. Generally, the internal offset should not exceed about 200 μm to prevent adversely affecting the quality of the measurement.

The EFPI sensor 12 may be fixed to the ferrule with an adhesive 25. As shown in FIG. 4, the adhesive 25 is securing the EFPI sensor 12 to the ferrule 15 at the end opposite of the internal offset such that the adhesive does not interfere with the broadband light and measurement. The EFPI sensor may be adhered to the ferrule in any way that is commonly known to one skilled in the art. According to one embodiment the EFPI sensor is adhered to the ferrule with a cyanoacrylate adhesive.

In one embodiment, the ferrule of the sensor is approximately 1.25 mm in diameter. The EFPI sensor diameter is approximately 127 μm.

### EFPI Sensor Array

Another embodiment of the invention includes measuring the distance from a cast metal surface at a plurality of locations using an EFPI. The method comprises providing the EFPI comprising a sensor, a reflector, and a broad band light source; positioning the EFPI such that the broad band light source is generally perpendicularly incident to the surface of the cast metal and reflected back to the reflector of the EFPI to produce an interference pattern read by the sensor of the EFPI; and generating a signal from the interference pattern read by the sensor corresponding to the distance between the surface of the cast metal and the surface of the reflector.

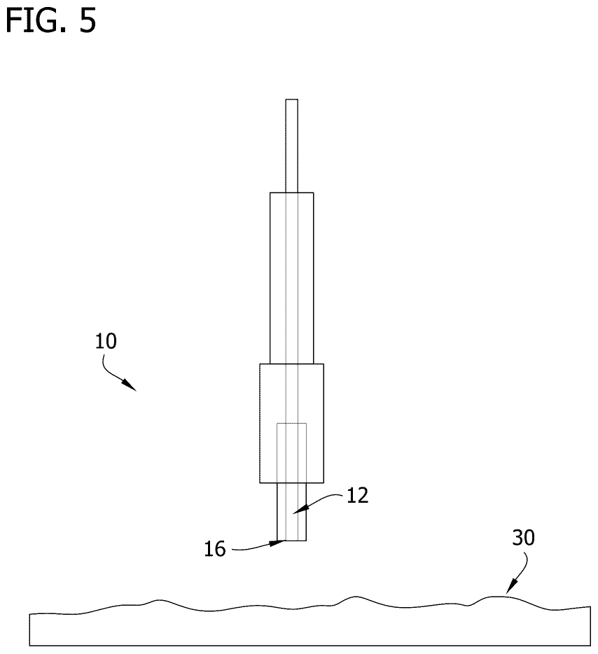

FIG. 5 is a schematic illustration of an EFPI sensor and a casted metal surface. An EFPI sensor 12 is positioned generally perpendicular to a cast metal surface 30. The cast metal surface 30 is at a first position and the end of the EFPI sensor 12 is located at a second position. The EFPI sensor 12 is positioned generally perpendicular to the cast metal surface 30. In this embodiment, the EFPI 10 is measuring the distance between the cast metal surface 30 and the EFPI reflector 16.

In one embodiment, the EFPI sensor or the cast metal surface may move relative to the other such that the distance between the cast metal surface is measured at a plurality of locations on the surface of the cast metal in the direction of movement. The movement of the cast metal surface is along the plane created by the surface of the cast metal and the movement of the EFPI is along the plane created by the mirror of the EFPI. The distance between the cast metal surface and the reflector varies based on the topography of the uneven surface of the cast metal. Since the maximum range of EFPI sensors is typically around 3 mm, the cast metal surface should be within this range relative to the EFPI sensor.

In another embodiment, the method may be conducted using a plurality of EFPI sensors in an array. There may be any number of EFPI sensors; in one embodiment the EFPI array may include 4 or more EFPI sensors. The EFPI sensor array may be configured linearly or in a grid. In similar fashion, the EFPI sensor array or the cast metal surface moves relative to the other such the distance between the cast metal surface is measured at a plurality of locations on the surface of the cast metal in the direction of movement.

The EFPI or EFPI array may measure the distance between the cast metal and the EFPI reflectors as the cast metal is cooling/solidifying. The cast metal is typically at a temperature between 60° and 1600° C. The array of a plurality of sensors is configured such that the EFPI reflectors create a plane no more than 3 mm from the surface of the cast metal. The EFPI array is constructed out of material that is able to withstand high temperatures for long durations. In one embodiment, the EFPI array is constructed out of stainless-steel. EFPI sensors have been shown to perform well at temperature around 1250° C.

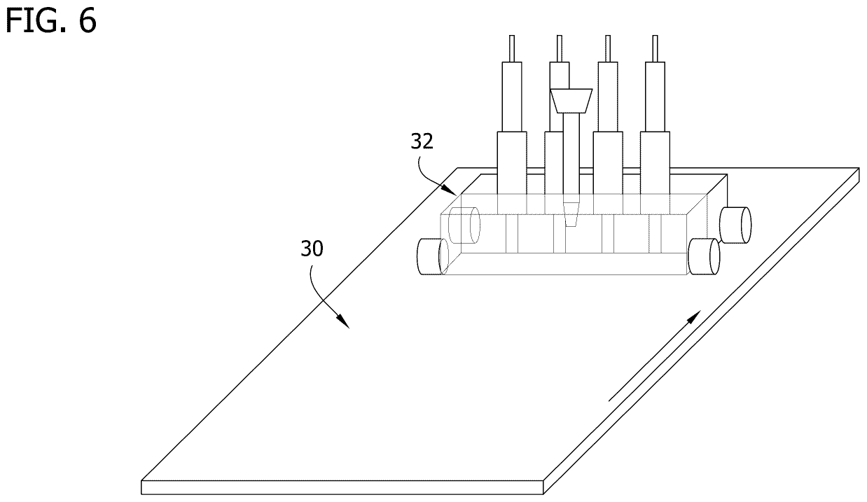

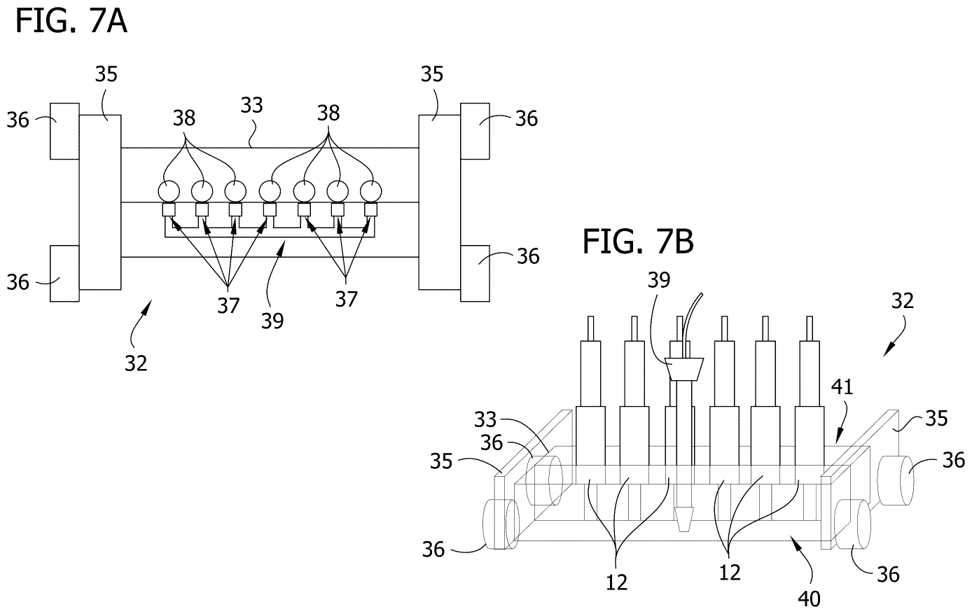

Turning to FIG. 6, here the cast metal surface 30 is configured to move relative to the EFPI sensor array 32. FIG. 7(a) shows the underside of the EFPI sensor array 32 which is exposed to the cast metal surface 30 (not shown). The EFPI sensor array 32 has a block 33 coupled to side rails 35 coupled to wheels 36. The EFPI sensor array 32 may have any number of wheels to allow the EFPI sensor array to move along the surface of the cast metal 30. The wheels may be any size that is appropriate to move the sensor block along the surface of the cast metal at the desired speed. For example, the wheels may have a 2-inch diameter. Also shown in FIG. 7(a), the block 33 has a plurality of ports 38 that are configured to receive EFPI sensor. The ports 38 may be equally spaced. The manifold 37 is configured to distribute compressed air adjacent to each port 38 through air vents 37. The block 33 may be constructed with two halves with the cross section along the port(s) 38 such that the access to the EFPI sensors is achieved by removing half of the block 33 from the EFPI array 32 when the array is coupled to side rails 35. For example, as shown in FIG. 7(b), the first half 40 of the block 33 may be removed to expose the EFPI sensors 12 while the second half 41 of the block 33 remains coupled to the side rails 35.

FIG. 7(b) shows the EFPI sensor array 32 from above. The EFPI sensor array 32 may have a pipe 39 to provide high pressure air. As the EFPI sensor array 32 or the casted metal surface 30 (not shown) moves relative each other the air makes contact with the casted metal surface 30 to ensure the casted metal surface 30 is clear of dust, dirt, or any other matter that may interfere with the EFPI broadband light making contact with the casted metal surface 30.

The EFPI sensors are connected to an optical integrator for data acquisition. In one particular embodiment, the optical integrator is a Micron-Optics Hyperion SI-255 enhance visibility optical integrator with a broad wavelength band from 1460 nm to 1620 nm. A computer connected to the optical integrator measures/calculates the varying Free Spectral Range (FSR).

The EFPI sensor may be connected to the data acquisition device running software with a fiber. For example, the fiber may be single-mode silica fiber. The fiber may be in a protective tubing such as a stainless-steel tube or any other tube that is commonly used by one with ordinary skill in the art.

Having described the invention in detail, it will be apparent that modifications and variations are possible without departing from the scope of the invention defined in the appended claims.

### Examples

The following non-limiting examples are provided to further illustrate the present invention.

### Example 1: Positioning the EFPI Sensor within a Mold

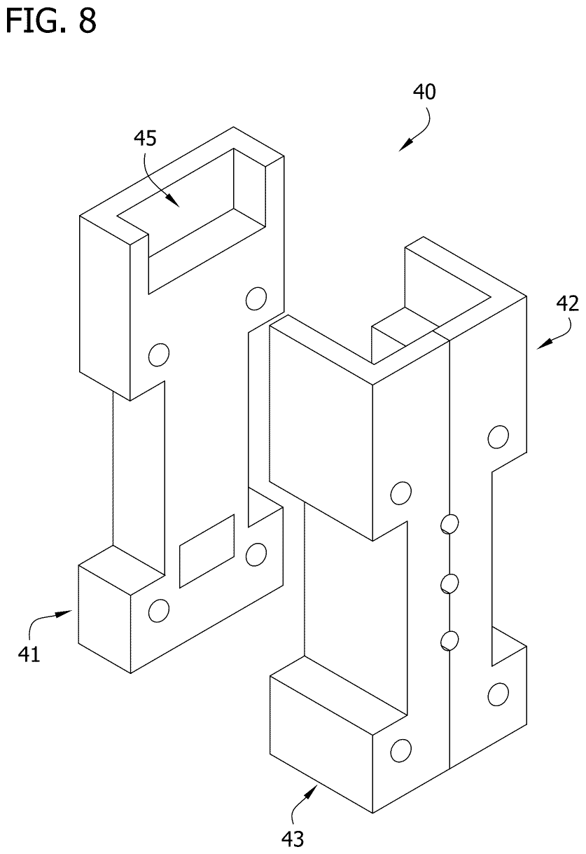

For ease of EFPI installation, the mold 40 was designed to have 3 parts as shown in FIG. 8. The front component 41 of the mold 40 was designed to have an opening 45 at the top to allow the molten mold flux sample to flow through the mold with minimal friction and simultaneously have contact with all components of the mold (i.e., the front component 41, the back-right component 42, and the light-right component 43). The front component 41 is a plane wall which has a smooth finish for good reflection from which light from the EFPIs are reflected.

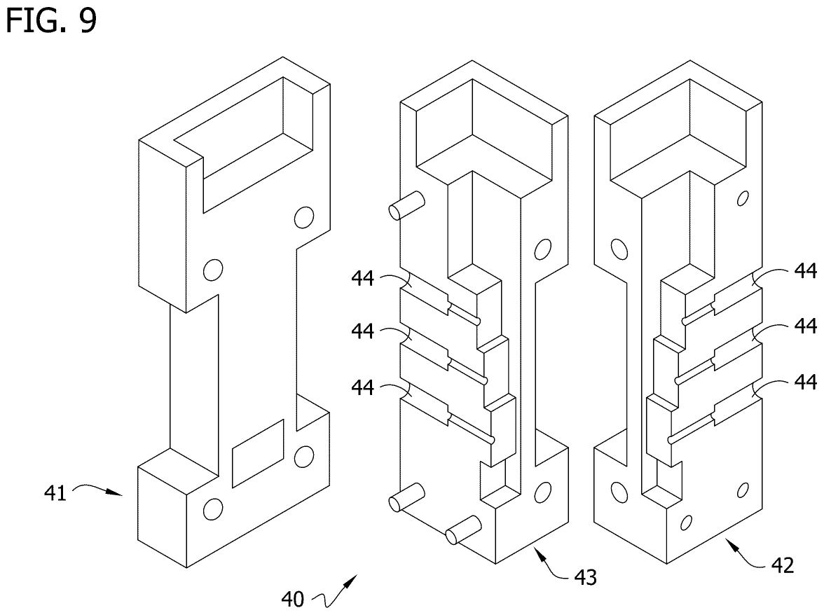

An alternative view of the mold design is shown in FIG. 9. The back component of the mold is split into two parts (i.e., back-right component 42, back-left component 43) having step profiles of 2 mm, 4 mm, and 6 mm. These two mold parts have grooves 44 in the center such that, when they are joined, they form holes of 1.27 mm inner diameter while retaining the step profile. The holes are used to house and clamp the EFPI ferrules containing the SMF. The EFPIs were installed in the grooves on the left side of the back component with cyanoacrylate adhesive. The front component 41 of the mold is bolted to the back components 42, 43 after EFPI installation such that the wall is facing the sensor. The single mode fiber cables are shielded with stainless-steel tubing for protection from high temperatures. The back-right component 42 was combined with the back-left component 43 to provide an enclosure and to affix the ferrules in place. Both parts of the back component 42, 43 were held together with bolts. The front component 41 was placed in contact with the back components 42, 43 such that all the EFPIs are exactly perpendicular to the wall.

The fibers extending from the EFPI sensors were protected by thin stainless-steel tube, that protrude from the back of the mold. The stainless-steel tubes are firmly attached to the back of the mold by means of a high temperature adhesive which was cured with a torch. The sensors were then connected to an optical integrator controlled by computer.

### Example 2: Measuring Gap Size in Aluminum Mold

Molten aluminum liquid at 650° C. was poured into the designed mold, filling the inner cavity. The designed mold was similar in configuration to FIG. 3 with respect to the distributed temperature sensor housed in a stainless steel housing along the mold wall and the mold opening and two EFPI installed opposite of one another. The mold opening at the location of the EFPI sensors had a length of 25.400 mm.

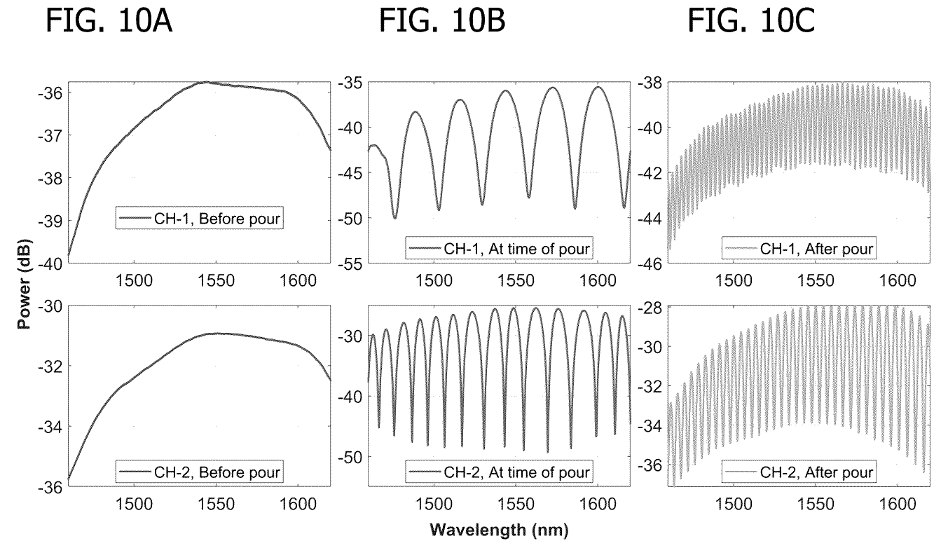

To ensure accurate and reliable measurements, the Micron-Optics Hyperion SI-255 optical broadband integrator was employed to capture interferograms at regular time intervals, as depicted in FIG. 10. The Hyperion SI-255 integrator collected interferograms consisting of 20,000 points within a wavelength band of 1460 nm to 1620 nm. These interferograms were then processed using a custom low finesse EFPI demodulation algorithm to estimate the gap size in real-time. Data collection was carried out continuously for an average duration of one hour, generating a comprehensive dataset for further analysis. The interferograms captured before the molten aluminum pouring are displayed in FIG. 10(a). Due to limitations of the integration system, the maximum measurable gap is only 3.5 mm, which is significantly smaller than the size of the mold cavity. As a result, the fringe visibility in the signal appears to be very low. To illustrate the change in gap size and free spectral range (FSR) during pouring, two interferograms from each EFPI were selected and are presented in FIG. 10(b). It is evident that the second reflection occurred when the aluminum surface was present, and an EFPI cavity was formed as soon as the aluminum was poured, resulting in the generation of the interferogram signal. Finally, to demonstrate the effect of solidification after pouring, two additional interferograms were chosen and are depicted in FIG. 10(c).

The FSR value in FIG. 10(c) is lower than that in FIG. 10(b), indicating a longer gap size according to Eq. (3). The comparison of the results from FIGS. 10(b) and 10(c) confirms the solidification effect after pouring. Once the solidification process is complete, the aluminum ingot undergoes complete shrinkage, forming a constant EFPI cavity and an optical standing wave. The interferogram remains stable and consistent due to the unchanging gap size. Advanced signal processing techniques are employed to analyze the interferograms and calculate the gap size. These techniques involve zero-crossing and spectrum reconstruction to extend the measurement range to larger gap sizes and improve measurement precision. By utilizing the zero-crossing technique, the location of the zero-crossing point in the signal can be accurately determined, serving as a reference for calculating the gap size with high precision. The spectrum reconstruction technique helps eliminate phase noise, reducing measurement uncertainty. These advanced signal processing techniques extract important information about the gap size and contribute to the overall accuracy of the measurement. With the use of these techniques, the EFPI system achieves a wider and more accurate measurement range of 10 μm to 3.5 mm, making it suitable for a broader range of applications.

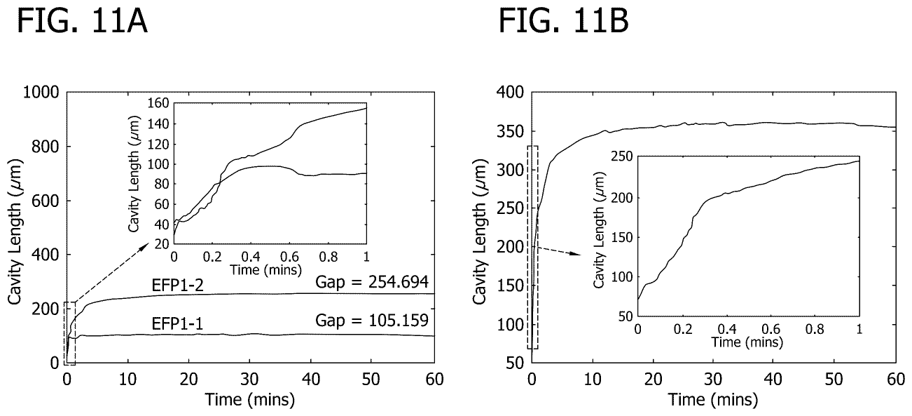

By employing this methodology, precise and detailed information regarding the gap size changes during aluminum solidification was obtained, enabling a deeper understanding of the studied system, as depicted in FIG. 11. The demodulation results obtained from two EFPIs played a crucial role in understanding the shrinkage behavior of a molten aluminum cast part during cooling, which will be useful in steelmaking and continuous casting processes.

Gap size variations of EFPI-1 and EFPI-2 were measured and plotted against time, as shown in FIG. 11(a). EFPI-1 showed a change of 105.159 μm from the beginning of the experiment to 60 minutes, indicating that the aluminum had solidified. In contrast, EFPI-2 recorded a larger change of 254.691 μm within the same period. Moreover, a zoom-in plot demonstrated the first minute of gap measurement during the aluminum solidification. When the molten aluminum is poured into the mold, it initially flows into the mold cavity and begins to fill the available space. As the aluminum material encounters the mold surfaces, it tends to solidify and shrink quickly, resulting in the generation of the mold gap. The total shrinkage of the aluminum sample was then calculated, and the result was plotted in FIG. 11(b). The zoom-in plot provides a clear visualization of the initial shrinkage that occurs during the solidification process. Notably, within the first 0.3 minutes, a significantly higher rate of aluminum shrinkage is observed.

### Example 3: EFPI Sensor Array Measures Cast Metal Slabs

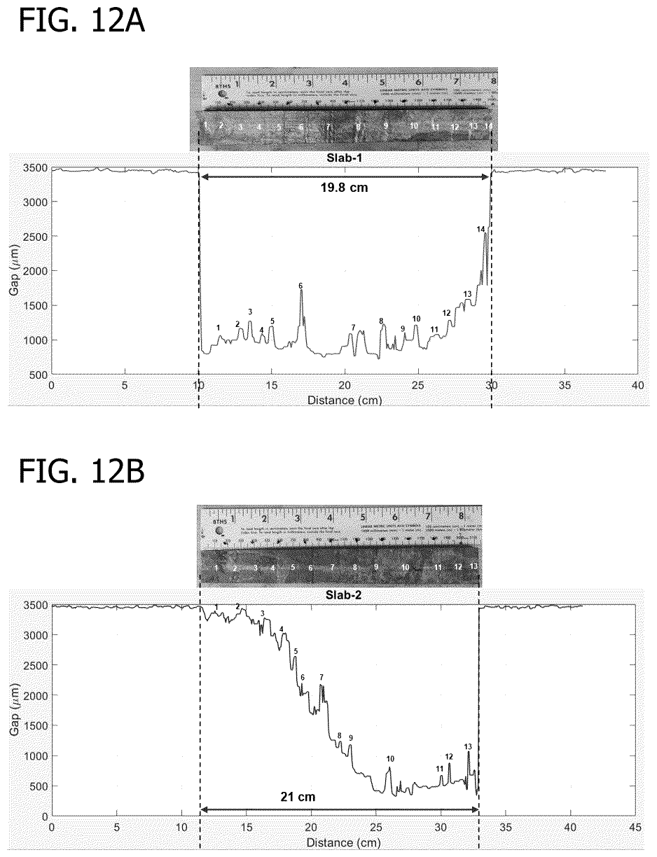

The experiment was set up by positioning a cast slab, measuring approximately 10 feet long, 1-foot-wide, and 3 inches thick, on a bench. Smooth steel rails, each no more than 1.5 mm thick, were placed along the edges of the slab to allow the EFPI sensor array to glide smoothly across the slab surface. The EFPI sensor array, containing 5-6 sensors in a linear arrangement, was manually moved along an 8-inch section of the slab along its length at an approximate speed of 40 inches per minute. Data acquisition occurred at a rate of 10 to 100 or more gap measurement snap shots per second, allowing the spatial dimension of the slab surface to be encoded into temporal measurements. The recorded gap size variations reveal the surface oscillations, where peaks in the data correspond to oscillation marks. Flat regions (about 10 cm in length) in FIGS. 12A and 12B represent sections where the EFPI sensor was stationary, measuring a constant gap size of approximately 3.5 mm above the slab surface, prior to and following rastering.

FIGS. 12A and 12B illustrate the surface oscillation measurements for two slab sections. The initial and final flat regions, spanning approximately 10 cm each, indicate periods when the EFPI array was stationary. During the active manual rastering phase (the central 20 cm in FIG. 12A and slightly longer in FIG. 12B), the gap size variations reveal the oscillation marks. Deviations in oscillation spacing, likely caused by manual movement inconsistencies.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above constructions, products, and methods without departing from the scope of the invention, it is intended that all matter contained in the above description and shown in the accompanying drawings shall be interpreted as illustrative and not in a limiting sense.

1. A method of measuring distance from a metal surface using an Extrinsic Fabry-Perot interferometer (EFPI), comprising:
directing a broadband light source of the EFPI onto a metal surface located at a first position and reflecting the light waves incident thereon to a reflector of the EFPI located at a second position to produce an interference pattern read by a sensor of the EFPI,
generating a signal from the interference pattern read by the sensor corresponding to the distance between the first position and the second position.

2. The method of claim 1, wherein the metal is cast within a mold comprising a wall having a surface defining a cavity in which the metal is cast and the method is used to determine the gap size formed between the surface of the mold and the surface of the cast metal as the metal solidifies.

3. The method of claim 2, wherein the reflector of the EFPI located at the second position is housed in a ferrule disposed within the wall of the mold and internally offset from the surface defining the cavity in which the metal is cast.

4. The method of claim 2, further comprising:
measuring the gap size between the surface of the mold and the surface of the cast metal at a plurality of locations simultaneously by positioning a plurality of EFPIs within the mold at each location.

5. The method of claim 2, wherein the sensor is internally offset from the surface of the cast model by about 50 μm to about 130 μm.

6. The method of claim 2, wherein the gap size is less than about 400 μm.

7. The method of claim 2, wherein the casted metal comprises aluminum.

8. The method of claim 2, wherein the cast metal is a liquid.

9. The method of claim 8, wherein the liquid metal is between 60° and 1600° C.

10. A method of measuring the distance from a cast metal surface at a plurality of locations using an Extrinsic Fabry-Perot Interferometer (EFPI), the method comprising:
providing the EFPI comprising a sensor, a reflector, and a broad band light source,
positioning the EFPI such that the broad band light source is generally perpendicularly incident to the surface of the cast metal and reflected back to the reflector of the EFPI to produce an interference pattern read by the sensor of the of the EFPI,
generating a signal from the interference pattern read by the sensor corresponding to the distance between the surface of the cast metal and the surface of the reflector.

11. The method of claim 10, further comprising:
moving the cast metal surface or the EFPI relative to the other such that the distance between the cast metal surface is measured at a plurality of locations on the surface of the cast metal in the direction of movement,
wherein the movement of the cast metal surface is along the plane created by the surface of the cast metal and the movement of the EFPI is along the plane created by the mirror of the EFPI.

12. The method of claim 10, further comprising:
measuring the distance from a cast metal surface at a plurality of locations simultaneously,
providing an EFPI array comprising a plurality of EFPI wherein each EFPI comprises a senor, a broad band light source, and a reflector,
positioning the EFPI array such that the broad band light source of each EFPI is generally perpendicularly incident on the surface of the cast metal at the plurality of locations, and reflected back to the reflector of each of the EFPI to produce an interference pattern at each location,
generating a signal from the interference pattern read by the sensor of each EFPI corresponding to the distance between the surface of the reflector and the surface of the cast metal at each location.

13. The method of claim 12, further comprising:
moving the cast metal surface or the EFPI array relative to the other such that the distance between the cast metal surface is measured at a plurality of locations on the surface of the cast metal in the direction of movement,
wherein the mirrors of each EFPI array create a plane, and
the movement of the EFPI array is along the plane created by the EFPI reflectors and the movement of the cast metal surface is along the plane created by the surface of the cast metal surface.

14. The method of claim 12, wherein the plurality of EFPI is configured linearly in the EFPI array in the longitudinal direction.

15. The method of claim 14, wherein the EFPI array moves in the longitudinal direction.

16. The method of claim 12, wherein the EFPI array is positioned such that the distance between the sensor and the cast metal surface is less than about 3 mm.

17. The method of claim 11 wherein the speed of movement is from about 10 inches per minute to about 90 inches per minute.

18. The method of claim 11 further comprising:
contacting the locations of the surface of the cast metal with air.

19. An EFPI array for measuring the distance from a cast metal surface at a plurality of locations simultaneously, the EFPI array comprising:
a plurality of EFPI is arranged in a linear configuration along a longitudinal axis;
two supports on either side of the EFPI array and opposite from each other along the longitudinal axis for supporting the plurality of EFPI at a uniform distance from the cast metal surface; and
at least one wheel attached to each of the supports for moving the EFPI array relative to the cast metal surface.

20. The EFPI array of claim 19, further comprising:
a compressed air pipe configured to deliver compressed air to each EFPI such that air is contacted with the surface of the cast metal at each of the locations.
